(19) United States
(12) Patent Application Publication
(10) Pub. No.: US 2010/0185788 A1
(43) Pub. Date: Jul. 22, 2010

(54) Electronic device, manual provision system having the same, and manual provision method

(75) Inventors: Jin Ho Kim, Suwon-si (KR); Kyung Jun Yoo, Suwon-si (KR); Byoung Oh Park, Suwon-si (KR); Yong Ki Cho, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 12/656,025

(22) Filed: Jan. 13, 2010

(30) Foreign Application Priority Data
Jan. 19, 2009 (KR) 10-2009-4311

(51) Int. Cl. G06F 13/00; G06F 15/16; G06F 3/00

(52) U.S. Cl. 710/19; 710/302; 709/219

(57) ABSTRACT

Disclosed is a system for providing a manual. The system includes a memory device storing the manual, a port into which the memory device is inserted, and an electronic device provided with a display unit that displays the manual if the portable memory device is connected with the port. According to the system, manuals of various electronic devices are stored in a portable memory device, and the manuals are displayed on the electronic devices after the portable memory device is connected with the electronic devices whenever the manuals are necessary, so that users may more easily locate and refer to the manuals.

### CROSS-REFERENCE TO RELATED APPLICATION

This application claims the benefit of Korean Patent Application No. 10-2009-0004311, filed on Jan. 19, 2009, in the Korean Intellectual Property Office, the disclosure of which is incorporated herein by reference.

### BACKGROUND

1. Field

One or more embodiments of the present disclosure relate to an electronic device capable of providing users with usage information by displaying a manual, a manual provision system having the same and a manual provision method.

2. Description of the Related Art

A provider of an electronic device provides users with a manual prepared in the form of a bound paper or plastic book or pamphlet such that the users can easily use the electronic device. The manual typically includes an introduction, installation methods, usage methods, functions, malfunction treatment methods, and items to be taken into consideration when the electronic device is used.

Most users who purchase an electronic device learn basic functions of the electronic device by using a manual, and refer to the manual when special functions, which are rarely used, are required. However, most users do not carefully store the manual in a fixed place, so the users may lose the manual or do not remember the place where the manual is stored if much time lapses after purchasing the electronic device. Thus, the users may feel inconvenienced when using the electronic device because they are not fully aware of the functions of the device, or the users have to pay for additional charges for telephone conversations or online conversations with an AS service center.

Further, since the provider has to provide the manual of the electronic device in the form of a bound paper book or pamphlet, the manufacturing cost for the manual may be increased. In Europe, since the manual is provided in eight languages, significant cost is required.

Furthermore, when a new model having new functions is launched, an updated manual must be provided. Although the updated manual reflecting the new model is substantially identical to the manual of the previous model, with the exception of the added descriptions about the new functions, the manual of the new model must be newly manufactured. Thus, the cost, time and labor for manufacturing the manual of the new model are required. That is, a cost effective upgrade for the manual prepared in the form of a paper book is impossible.

In order to solve the above problems, a scheme to manufacture and propose a manual online has been proposed, such as through the Internet. However, in this case, the electronic device needs to be connected with the Internet via a modem or a network.

### SUMMARY

Additional aspects and/or advantages of the disclosure will be set forth in part in the description which follows and, in part, will be apparent from the description, or may be learned by practice of the disclosure.

It is an aspect of the disclosure to provide an electronic device capable of providing users with usage information by displaying a manual, a manual provision system having the same and a manual provision method.

The foregoing and/or other aspects of the disclosure are achieved by providing a manual provision system including a portable memory device storing a manual, and an electronic device provided with a display unit that displays the manual upon the portable memory device being connected to the electronic device.

The portable memory device includes a universal serial bus (USB) memory device.

The portable memory device includes a flash memory device.

The system further includes a server that stores various manuals, wherein the portable memory device receives at least one manual from the server and then stores the manual.

The manual stored in the portable memory device is upgradable.

The system further includes a user terminal that communicates with the server upon the portable memory device being connected to the electronic device.

The electronic device includes a television that displays external broadcast signals.

The television displays the manual on a part of the display unit and displays image signals of the broadcast signals on a remaining part of the display unit.

The manual is stored in a form of at least one of a dynamic image file, a picture file, a text file and a flash file.

According to another aspect, there is provided an electronic device including a port, a controller that determines if a memory device is connected with the port, and checks if a manual exists in the memory device to control display of the manual when the memory device is connected with the port, and a display unit that displays the manual under control of the controller.

The port includes a USB port.

The manual includes a plurality of items, and the controller determines a current mode, and determines an item of the manual corresponding to the current mode such that the item is displayed.

According to further another aspect, there is provided a manual provision method including determining a connection state of a memory device, and controlling display of a manual on the electronic device when the connection state of the memory device is determined as being connected to the electronic device.

The memory device includes a USB memory device.

The method further includes checking if the manual of the electronic device exists in the memory device upon the connection state of the portable memory device.

The controlling of the display of the manual on the electronic device further includes determining a current mode of the electronic device, and displaying an item of the manual corresponding to the current mode.

The controlling of the display of the manual on the electronic device further includes displaying the manual on a part of the electronic device when a function of the electronic device is adjusted by a user, and displaying an adjustment result on a remaining part of the electronic device.

The manual is displayed on the electronic device in a form of one of a text, a dynamic image and a picture.

The controlling of the display of the manual on the electronic device further includes determining if the memory device is separated from the electronic device, and completing the display of the manual when the memory device is separated from the electronic device.

The controlling of the display of the manual on the electronic device further includes determining if a display stop signal is input from a remote controller, and completing the display of the manual when the display stop signal is input from the remote controller.

The controlling of the display of the manual on the electronic device further includes determining if an item of the manual displayed on the electronic device represents one of a usage method, an installation method and functions, and sequentially displaying information corresponding to the item of the manual such that a user is fully aware of the information.

According to further another aspect, there is provided a manual provision method including receiving a manual from a server and storing the manual in a portable memory device, determining a connection state of the portable memory device, and displaying the manual on an electronic device when the connection state of the portable memory device is determined as being connected to the electronic device.

The receiving of the manual from the server further includes connecting the portable memory device with a user terminal, performing communication between the user terminal and the server, and receiving the manual of the electronic device from the server.

The portable memory device is connected with the user terminal such that USB communication is performed between the portable memory device and the user terminal.

The manual is displayed on the electronic device through USB communication between the portable memory device and the electronic device.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a block diagram illustrating a manual provision system provided with an electronic device according to an embodiment;

FIG. 2 is a block diagram illustrating a manual provision system provided with a television according to another embodiment;

FIG. 3 is a flowchart illustrating a manual provision method according to another embodiment;

FIG. 4 is a diagram illustrating a display unit of a manual provision system according to another embodiment; and

FIG. 5 is a block diagram illustrating a manual provision system according to still another embodiment.

### DETAILED DESCRIPTION

Reference will now be made in detail to embodiments, examples of which are illustrated in the accompanying drawings, wherein like reference numerals refer to the like elements throughout. Embodiments are described below to explain the present disclosure by referring to the figures.

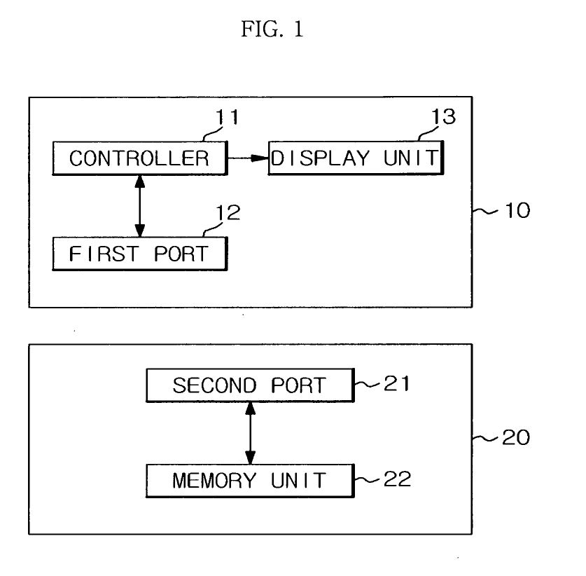

FIG. 1 is a block diagram illustrating a manual provision system provided with an electronic device according to an embodiment. The system includes an electronic device 10 and a memory device 20.

The electronic device 10 may include, for example, an appliance such as a microwave oven, an air conditioner, a washing machine or a refrigerator, each being capable of displaying a manual. The electronic device 10 may equally include, for example, a television, a video cassette recorder, an optical disk player or a tuner, each also being capable of displaying a manual. The electronic device 10 may include a controller 11, a first port 12 and a display unit 13.

In an embodiment, the memory device 20 is a separate device from the electronic device 10. After the electronic device 10 is powered on, the controller 11 determines a connection state of the memory device 20 through the first port 12. That is, if the memory device 20 is connected with the electronic device 10, the controller 11 determines if a manual of the electronic device 10 is stored in the memory device 20. The memory device 20 may be electrically connected to the electronic device 10. If the manual is stored in the memory device 20, the controller 11 controls the display unit 13 to display the manual. Further, the controller 11 determines a separation state of the memory device 20 through the first port 12. If the memory device 20 is separated from, i.e., disconnected from, the electronic device 10, the controller 11 controls the display unit 13 to stop displaying the manual.

When the controller 11 controls the display unit 13 to display the manual, the controller 11 determines the current mode of the electronic device 10 to control the display unit 13 to display items of the manual corresponding to the current mode. In detail, the manual may include a plurality of items such as an introduction, installation methods, usage methods, functions, notes, and malfunction treatment methods such as troubleshooting methods. Each of the items may have identification number (ID) information. The electronic device 10 may include a plurality of modes having ID information. Since the ID information of each item of the manual corresponds to the ID information of each mode of the electronic device 10, the electronic device 10 can display the items of the manual corresponding to the current mode thereof.

In an embodiment, the first port 12 is provided at an outer portion of a body (not shown) of the electronic device 10 while being provided at one side of the display unit 13 to facilitate connection. The memory device 20 is selectively connected with the first port 12 by a user. In detail, a second port 21 of the memory device 20 is inserted into the first port 12, so the electronic device 10 is electrically connected with the memory device 20. Thus, the first port 12 may provide a path through which the manual in the memory device 20 is transmitted to the controller 11 of the electronic device 10.

The display unit 13 may be prepared in the form of a flat panel display such as a liquid crystal display (LCD), a plasma display panel (PDP), an organic light emitting diode (OLED) or a light emitting diode (LED), and displays the manual under the control of the controller 11.

As described above, the memory device 20 is connected with the first port 12 of the electronic device 10 so that the controller 11 of the electronic device 10 may control the manual in a memory unit 22 of the memory device 20 to be displayed through the display unit 13.

The memory device 20 may include the second port 21 and the memory unit 22.

The second port 21 is connected with the first port 12 of the electronic device 10 by a user, and the memory unit 22 stores the manual. The manual is stored in the memory unit 22 in the form of a dynamic image file, a picture file, a flash file and a text file, for example.

In an embodiment, the memory unit 22 of the memory device 20 is a readable and writable USB memory, the second port 21 is a USB port through which a file stored in the USB memory may be transmitted, and the memory device 20 is a portable memory device carried by a user. Further, the memory unit 22 of the memory device 20 has capacity for storing various other files in addition to the manual.

As described above, when the memory device 20 is electrically connected with the electronic device 10, the manual stored in the memory unit 22 of the memory device 20 is transmitted to the electronic device 10 through the second port 21.

As described above, manuals of various electronic devices are stored in a portable memory device, and the manuals are displayed on the electronic devices after the portable memory device is connected with the electronic devices whenever the manuals are desired by a user, so that the user may easily refer to the manuals. Thus, convenience to users may be improved. Further, the memory device can be individually utilized in order to enhance user satisfaction.

Further, the memory device storing the manuals may be provided to the users free of charge in order to further enhance user satisfaction. In addition, waste and environmental contamination caused by manuals discarded in the form of paper or plastic books may be reduced. Moreover, since the memory device is used instead of paper or plastic books, the size and weight of a box containing parts may be reduced, resulting in reduced physical distribution costs.

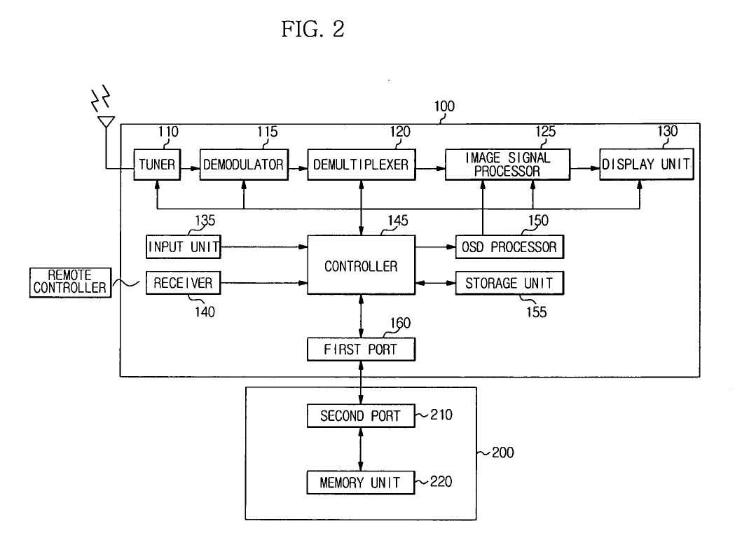

FIG. 2 is a block diagram illustrating a manual provision system provided with a television. The system may include the television 100 and a memory device 200. The television 100 is one example of an electronic device. For other electronic devices that typically lack a display such as a refrigerator, the display may be added to the device. For example, in an embodiment the display may be embedded in an exterior front or side surface of the refrigerator.

The television 100 may include a tuner 110, a demodulator 115, a demultiplexer 120, an image signal processor 125, a display unit 130, an input unit 135, a receiver 140, a controller 145, an on screen display (OSD) processor 150, a storage unit 155 and a first port 160.

The tuner 110 selects a broadcast signal of a channel desired by a user, from broadcast signals received from a broadcast station, and transmits the selected broadcast signal to the demodulator 115. The demodulator 115 demodulates the broadcast signal to transmit the demodulated broadcast signal to the demultiplexer 120. The demultiplexer 120 divides the demodulated broadcast signal into an image signal, an audio signal and additional information. The image signal processor 125 processes the image signal such that the image signal can be displayed on the display unit 130. Further, when the memory device 200 is connected with the television 100, the image signal processor 125 processes a signal of a manual file under the control of the controller 145. The display unit 130 displays the image signal processed by the image signal processor 125, and displays an image signal or information about the manual file, which is input from the OSD processor 150, on a screen thereof.

The display unit 130 may be in the form of a flat panel display such as a color display tube (CDT), a color picture tube (CPT), a multimedia display tube (MDT), an LCD, a PDP, an OLED or an LED, and displays the manual file or the image signal of the broadcast signals.

The input unit 135 receives a command from a user and transmits a signal corresponding to the command to the controller 145. The receiver 140 receives a signal from a remote controller and transmits the signal the controller 145. The remote controller controls functions of the television 100 remotely from the television 100. The remote controller is provided with a plurality of buttons pressed by the user and transmits a signal corresponding to a button pressed by the user to the receiver 140 of the television 100. The remote controller may also be used to control access to various portions of the manual such as an item, chapter, page, section, or line.

The controller 145 outputs at least one control signal, which is used to perform a control operation corresponding to the signal received from the input unit 135 or the receiver 140, to corresponding elements 110, 115, 120, 125, 130 and 150.

In more detail, if a power on signal is input from the input unit 135 or the receiver 140, the controller 145 controls the tuner 110, the demodulator 115, the demultiplexer 120, the image signal processor 125 and the display unit 130 to allow an image signal of broadcast signals of a channel previously selected to be displayed through the display unit 130. At this time, the controller 145 controls an audio signal of the broadcast signals of the channel previously selected to be output through a speaker (not shown). Further, if a channel switching signal is received from the input unit 135 or the receiver 140, the controller 145 controls an image signal of broadcast signals of a channel, which corresponds to the received signal, to be displayed through the display unit 130.

Further, if an OSD information display request signal is received from the input unit 135 or the receiver 140, the controller 145 controls the OSD processor 150 such that a message representing the OSD information is displayed through the display unit 130. Then, the controller 145 transmits a control signal to the OSD processor 150 such that a setting state of the OSD information is changed through the message according to a signal input from the input unit 135 or the receiver 140.

When a user requests OSD information display and manipulation using the remote controller or the input unit 135, the OSD processor 150 generates and processes the OSD information and transfers the OSD information to the image signal processor 125 under the control of the controller 145.

The OSD refers to the function to display information of a monitor required for a user, adjustment for various setting items, and an adjustment state thereof on the screen of the display unit 130. Such OSD information may include brightness, contrast, tuning, RGB adjustment, and adjustment for longitudinal and transverse sizes and positions of the screen.

Further, if a connection signal, which indicates a connection between the first port 160 and a second port 210 of the memory device 200, is transmitted from the first port 160, the controller 145 reads information on the manual file stored in the memory unit 220 of the memory device 200, and transmits the information to the image signal processor 125.

Then, the controller 145 controls the image signal processor 125 such that the manual is displayed on a part of the display unit 130 and a broadcast program of the selected channel is displayed on a remaining part of the display unit 130.

Further, if the connection signal is transmitted from the first port 160, the controller 145 determines a driving state of the television 100 to check a current operation mode and an ID corresponding to the operation mode. Then, the controller 145 searches for an item having the ID of the current operation mode based on the IDs of the items of the manual stored in the memory unit 220 of the memory device 200, and transmits file information on the searched item to the image signal processor 125.

The storage unit 155 stores ID information corresponding to various modes of the television 100.

In an embodiment, the second port 210 of the memory device 200 is inserted into the first port 160, so the television 100 is electrically connected with the memory device 200. Thus, the first port 160 may provide a path through which the manual stored in the memory device 200 is transmitted to the controller 145 of the television 100.

The first port 160 is provided at an outer portion of a body (not shown) of the television 100 while being provided at one side of the display unit 130. The memory device 200 is selectively connected with the first port 160 by a user.

When the memory device 200 is connected with the television 100, the controller 145 of the television 100 reads the manual from the memory unit 220 of the memory device 200, and controls the manual to be processed by the image signal processor 125 such that the manual is displayed through the display unit 130.

The memory device 200 may include the second port 210 and the memory unit 220. The second port 210 may be connected with the first port 160 of the television 100 by a user, while the memory unit 220 may be used to store the manual. When the first port 160 of the television 100 is connected with the second port 210 of the memory device 200, the manual is transmitted to the controller 145 of the television 100 through the second port 210 at the request of the controller 145. At this time, a file of the manual is stored in the form of at least one of a dynamic file, a picture file, a flash file and a text file. Further, each item of the manual has ID information corresponding to the ID information of various modes of the television 100.

In an embodiment, the memory unit 220 of the memory device 200 is a USB memory which is a readable and writable storage medium. The second port 210 is a USB port through which a file stored in the USB memory may be transmitted or received, and the memory device 200 is a portable memory which can be carried by a user. Further, the memory unit 220 of the memory device 200 has capacity for storing various other files in addition to the manual.

If the memory device 200 is electrically connected with the television 100, the manual file stored in the memory unit 220 of the memory device 200 is transmitted to the television 100 through the second port 210 of the memory device 200 and the first port 160 of the television 100.

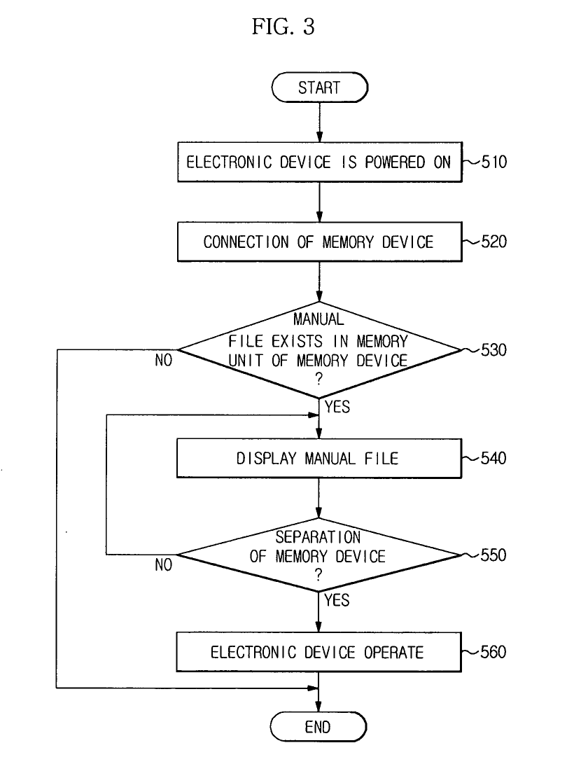

FIG. 3 is a flowchart illustrating a method by which the manual provision system provided with the television provides the manual.

Referring to FIGS. 2 and 3, the television 100 provided with the display unit 130 is powered on using the input unit 135 or the remote controller (510). After the television 100 is powered on, when a user wants to watch broadcast program through the television 100, the user selects a channel using the input unit 135 or the remote controller.

When the television 100 (electronic device) is powered on or while the user is watching the broadcast program, a situation may arise, for example, a situation in which an external device such as a speaker or an AV source device including a digital video disc player (DVDP) is required to be connected with the television 100, or a situation in which the television 100 operates abnormally. That is, an event may occur in which the user desires to refer to the manual of the television 100. At this time, the user inserts the memory device 200 into the first port 160 provided in the television 100 (520).

Upon electrical connection of the first port 160 of the television 100 and the second port 210 of the portable memory device 200, the controller 145 of the television 100 (electronic device) checks to determine if a manual file exists in the memory unit 220 of the portable memory device 200 (530). If no manual file exists in the memory unit 220 of the portable memory device 200, the controller 145 controls the display unit 130 to display a message representing that no manual exists in the memory device 200, and continues broadcasting a program of a current channel.

In contrast, if a manual exists in the memory unit 220 of the memory device 200, the controller 145 reads the manual from the memory device 200 to display the manual through the display unit 130. The manual may be provided by a television provider, or downloaded from a server when the manual has been lost.

Further, the controller 145 determines a current mode (operation state) of the television 100 such as an installation mode, an external device connection mode or an abnormal mode, and determines an ID corresponding to the current mode. Then, the controller 145 searches for an ID of an item of the manual corresponding to the determined ID, extracts the ID of the item of the manual, which coincides with the ID of the current mode of the television 100, and controls the display unit 130 to display information corresponding to the extracted item of the manual (540).

For example, when the television 100 is in the abnormal mode, the user inserts the memory device 200 into the first port 160 of the television 100. Then, the controller 145 controls the display unit 130 to display information of an item, which corresponds to the abnormal mode, of the manual stored in the memory device 200. The information of the item corresponding to the abnormal mode is used when the user checks an abnormal state of the television 100 to correct the abnormal state before calling an A/S center. Such information may include symptoms of the abnormal state, and treatments for the abnormal state.

After the memory device 200 has been inserted into the first port 160 of the television 100, if the television 100 is in a broadcast mode, the display unit 130 of the television 100 displays all items of the manual. Then, if one of the items is selected through the input unit 135 or the remote controller, details of the selected item and information corresponding to the selected item are displayed through the display unit 130.

At this time, if the user selects notes, the display unit 130 displays information about the notes. The information may include instructions which are taken into consideration when using the television 100 (electronic device) in order to prevent unexpected accident or damage.

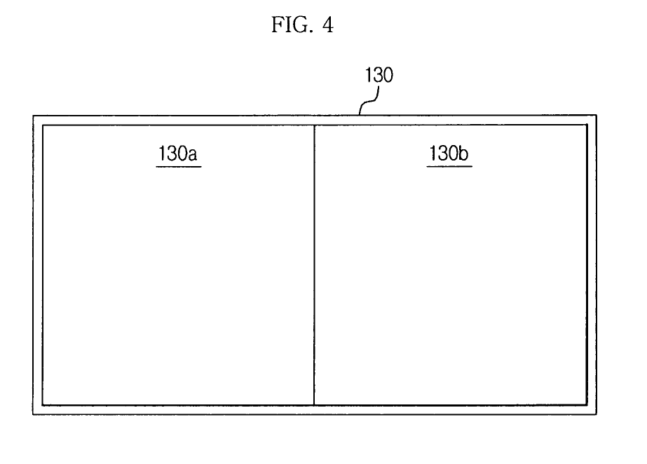

When the information of the manual is displayed through the display unit 130, the information of the manual can be displayed on a portion 130a of the display unit 130, and a broadcast program can be displayed on a remaining portion 130b of the display unit 130 as shown in FIG. 4.

Further, when the user wants to control one function described on the manual, the controller 145 controls information on the items of the manual such that the information on the items is sequentially displayed on the part 130a of the display unit 130. Thus, the user can control the item while watching the information sequentially displayed on the display unit 130. After the user controls the items, an operation state of the television 100 can be displayed on the remaining part 130b of the display unit 130.

Further, when the information on the items of the manual is sequentially displayed on the part 130a of the display unit 130, the information on the items of the manual can be displayed on the subsequent screen of the display unit 130 as the user manipulates the remote controller or the input unit 135.

If the user does not want to display the manual, the user may stop the display of the manual by using the input unit 135 provided in the television 100 (electronic device), or the remote controller, or alternatively may separate the memory device 200 from the first port 160 of the television 100 (550). Then the display unit 130 of the television 100 will display a broadcast program of a previously selected channel instead of the manual.

Further, if a function of the television 100 is controlled by the user during the display of the manual, the controlled function is applied to the television 100. Then, the television 100 having the controlled function operates to display images (560).

The method for providing a manual according to the above-described embodiments may be recorded in computer-readable media or processor-readable media including program instructions to implement various operations embodied by a computer or processor. The media may also include, alone or in combination with the program instructions, data files, data structures, and the like.

Examples of computer-readable media or processor-readable media include: magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may also be configured to act as one or more software modules in order to perform the operations of the above-described embodiments, or vice versa. The method for providing a manual may be executed on a general purpose computer or may be executed on a particular machine such as the manual provision system provided with an electronic device described herein.

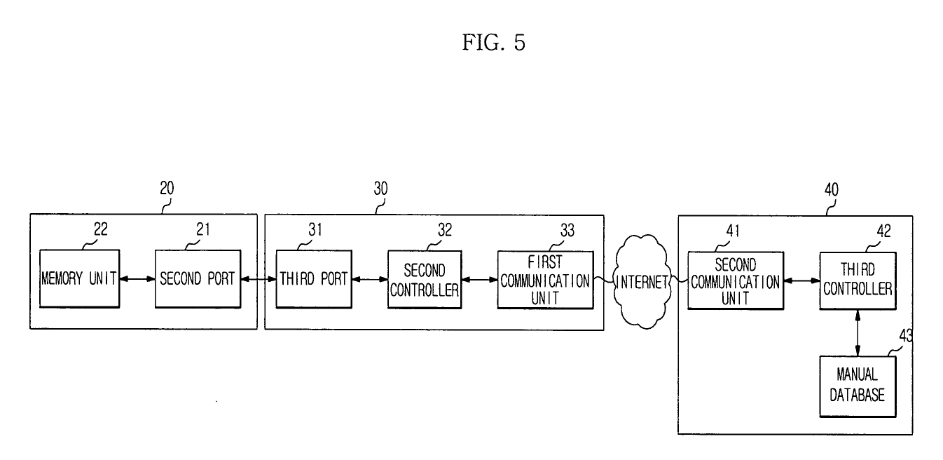

FIG. 5 is a block diagram illustrating a manual provision system according to another embodiment. The manual provision system may include an electronic device 10, a portable memory device 20, a user terminal 30 and a server 40. Since the electronic device 10 is identical to the electronic device 10 described in the previous embodiment, a detailed description thereof will be omitted.

The memory device 20 may include a second port 21 and a memory unit 22. The second port 21 may be selectively connected with the first port 12 of the electronic device 10 or a third port 31 of the user terminal 30 by a user, while the memory unit 22 may be used to store a manual. The manual in the memory unit 22 may be received from the server 40 through the user terminal 30 or provided by a provider when the user purchases the electronic device 10.

Further, the manual in the memory unit 22 of the memory device 20 can be deleted from the memory unit 22, and can be received from the server 40. Furthermore, a new version of the manual can be downloaded from the server 40 for upgrade.

In an embodiment, the memory unit 22 of the memory device 20 is a readable and writable USB memory, the second port 21 is a USB port, and the memory device 20 is a portable memory device which can be carried by the user.

The manual may be prepared in the form of at least one of a dynamic image file, a picture file, a flash file and a text file, and may include a plurality of items. The items have ID information corresponding to ID information of various modes of the electronic device 10.

As described above, if the memory device 20 is electrically connected with the user terminal 30 and the user terminal 30 communicates with the server 40, the memory device 20 receives the manual through the user terminal 30 and then stores the manual in the memory unit 22. Then, if the memory device 20 is connected with the electronic device 10, the manual in the memory unit 22 of the memory device 20 is transmitted to the electronic device 10 through the second port 21.

The user terminal 30 may include the third port 31, a second controller 32 and a first communication unit 33, and the server 40 may include a second communication unit 41, a third controller 42 and a manual database 43.

In detail, the second port 21 of the memory device 20 is inserted into the third port 31 of the user terminal 30. Thus, the second port 21 and the third port 31 may provide a path through which the manual may be transmitted to the memory unit 22 of the memory device 20 from the user terminal 30. Then, the second controller 32 of the user terminal 30 receives the manual from the server 40 by controlling communication of the first communication unit 33 at the request of the user. At this time, when a request for the manual is received, the user terminal 30 can select a file type of the manual and receive the manual of the selected file type from the server 40.

Thereafter, the second controller 32 of the user terminal 30 stores the manual received from the server 40. If the second port 21 of the memory device 20 is inserted into the third port 31 of the user terminal 30, the user terminal 30 transmits the manual to the memory unit 22 of the memory device 20.

The second communication unit 41 of the server 40 communicates with the first communication unit 33 of the user terminal 30 through the Internet. If a manual request signal is received from the user terminal 30, the third controller 42 of the server 40 transmits the manual corresponding to the model of the electronic device 10 to the user terminal 30. The manual database 43 of the server 40 stores manual files according to various models of the electronic device 10. The manual files are stored in the manual database 43 in the form of dynamic image files, picture files, flash files or text files.

As described above, even if the manual stored in the memory device is deleted, the manual can be downloaded from the server. Furthermore, the manual can be provided in the form of a dynamic image file such as a computer graphic file, a flash file or an animation file, so consumers may also conveniently use various functions, thereby improving utilization of the manual. In addition, the manual can be easily upgraded so that consumer perception of the electronic device is improved and the quality of a service provided to a customer from an electronic device supplier can also be improved.

Further, users around the world can easily download manuals interpreted in various languages through the Internet if necessary. Furthermore, an electronic device supplier provides users with a portable memory device storing a manual in the form of a file, instead of a book, so that time, cost and labor force required for manufacturing and distributing the manual can be reduced considerably.

Although few embodiments have been shown and described, it would be appreciated by those skilled in the art that changes may be made in these embodiments without departing from the principles and spirit of the disclosure, the scope of which is defined in the claims and their equivalents.

What is claimed is:

1. A system for providing a manual, the system comprising:
a portable memory device storing the manual; and
an electronic device provided with a display unit that displays the manual upon the portable memory device being connected to the electronic device.

2. The system of claim 1, wherein the portable memory device comprises a universal serial bus (USB) memory device.

3. The system of claim 1, wherein the portable memory device comprises a flash memory device.

4. The system of claim 1, further comprising a server that stores various manuals, wherein the portable memory device receives at least one manual from the server and then stores the manual.

5. The system of claim 4, wherein the manual stored in the portable memory device is upgradeable.

6. The system of claim 4, further comprising a user terminal that communicates with the server upon the portable memory device being connected to the electronic device.

7. The system of claim 1, wherein the electronic device comprises a television that displays external broadcast signals.

8. The system of claim 7, wherein the television displays the manual on a part of the display unit and displays image signals of the broadcast signals on a remaining part of the display unit.

9. The system of claim 1, wherein the manual is stored in a form of at least one of a dynamic image file, a picture file, a text file and a flash file.

10. An electronic device comprising:
a port;
a controller that determines if a memory device is connected with the port, and checks if a manual exists in the memory device to control display of the manual when the memory device is connected with the port; and
a display unit that displays the manual under control of the controller.

11. The electronic device of claim 10, wherein the port comprises a USB port.

12. The electronic device of claim 10, wherein the manual comprises a plurality of items, and the controller determines a current mode, and determines an item of the manual corresponding to the current mode such that the item is displayed.

13. A method for providing a manual, the method comprising:
determining a connection state of a memory device; and
controlling display of the manual on the electronic device when the connection state of the memory device is determined as being connected to the electronic device.

14. The method of claim 13, wherein the memory device comprises a USB memory device.

15. The method of claim 13, further comprising checking if the manual of the electronic device exists in the memory device upon the connection state of the portable memory device.

16. The method of claim 13, wherein the controlling of the display of the manual on the electronic device further comprises:
determining a current mode of the electronic device; and
displaying an item of the manual corresponding to the current mode.

17. The method of claim 13, wherein the controlling of the display of the manual on the electronic device further comprises:
displaying the manual on a part of the electronic device when a function of the electronic device is adjusted by a user; and
displaying an adjustment result on a remaining part of the electronic device.

18. The method of claim 13, wherein the manual is displayed on the electronic device in a form of one of a text, a dynamic image and a picture.

19. The method of claim 13, wherein the controlling of the display of the manual on the electronic device further comprises:
determining if the memory device is separated from the electronic device; and
completing the display of the manual when the memory device is separated from the electronic device.

20. The method of claim 13, wherein the controlling of the display of the manual on the electronic device further comprises:
determining if a display stop signal is input from a remote controller; and
completing the display of the manual when the display stop signal is input from the remote controller.

21. The method of claim 13, wherein the controlling of the display of the manual on the electronic device further comprises:
determining if an item of the manual displayed on the electronic device represents one of a usage method, an installation method and functions; and
sequentially displaying information corresponding to the item of the manual such that a user is fully aware of the information.

22. A method for providing a manual, the method comprising:
receiving a manual from a server and storing the manual in a portable memory device;
determining a connection state of the portable memory device; and
displaying the manual on an electronic device when the connection state of the portable memory device is determined as being connected to the electronic device.

23. The method of claim 22, wherein the receiving of the manual from the server further comprises:
connecting the portable memory device with a user terminal;
performing communication between the user terminal and the server; and
receiving the manual of the electronic device from the server.

24. The method of claim 23, wherein the portable memory device is connected with the user terminal such that USB communication is performed between the portable memory device and the user terminal.

25. The method of claim 22, wherein the manual is displayed on the electronic device through USB communication between the portable memory device and the electronic device.
